(19) United States
(12) Patent Application Publication
(10) Pub. No.: US 2018/0261827 A1
(43) Pub. Date: Sep. 13, 2018

(54) ELECTRODE, ELECTRODE ELEMENT, NONAQUEOUS ELECTROLYTIC POWER STORAGE DEVICE

(71) Applicants: Hideo YANAGITA, Tokyo (JP); Shigeo TAKEUCHI, Kanagawa (JP); Yuu ZAMA, Kanagawa (JP); Anna HIROWATARI, Kanagawa (JP); Aya YOSHIDA, Tokyo (JP); Toru USHIROGOCHI, Kanagawa (JP); Okitoshi KIMURA, Kanagawa (JP)

(72) Inventors: Hideo YANAGITA, Tokyo (JP); Shigeo TAKEUCHI, Kanagawa (JP); Yuu ZAMA, Kanagawa (JP); Anna HIROWATARI, Kanagawa (JP); Aya YOSHIDA, Tokyo (JP); Toru USHIROGOCHI, Kanagawa (JP); Okitoshi KIMURA, Kanagawa (JP)

(73) Assignee: Ricoh Company, Ltd., Tokyo (JP)

(21) Appl. No.: 15/899,837

(22) Filed: Feb. 20, 2018

(30) Foreign Application Priority Data
Mar. 8, 2017 (JP) 2017-044425
Jun. 15, 2017 (JP) 2017-117777

(51) Int. Cl. H01M 4/131; H01M 4/1391; H01M 4/66; H01M 10/0525; H01M 10/0585; H01M 10/0563

(52) U.S. Cl. CPC H01M 4/131; H01M 4/1391; H01M 4/661; H01M 2300/002; H01M 10/0585; H01M 10/0563; H01M 10/0525

(57) ABSTRACT

An electrode of a power storage device includes an electrode current collector; and electrode material layers stacked on one side of the electrode current collector, to store and discharge lithium ions. As an anode, each electrode material layer includes a first material and a second material that causes less deposit of the lithium ions on a surface of the anode than the first material, and the farther the electrode material layer is placed from the electrode current collector, the greater a ratio of a weight of the second material becomes. As a cathode, each of the electrode material layers includes a third material and a fourth material that has a higher diffusibility with respect to lithium ions than the third material, and the farther the electrode material layer is placed from the electrode current collector, the less a ratio of a weight of the fourth material becomes.

### BACKGROUND OF THE INVENTION

### 1. Field of the Invention

The present disclosure relates to an electrode, an electrode element, and a nonaqueous electrolytic power storage device.

### 2. Description of the Related Art

When discharging at a high current rate a conventional, thin, laminated power storage device using lithium ions, lithium ions in electrolyte included in an electrode are rapidly captured into an electrode active material, to reduce the concentration of lithium ions in the electrode, and in turn, lithium ions are supplied from an electrolyte layer in a separator.

When discharging the device at such a high current rate, since the concentration of solid contents is uniform within the electrode, it is difficult to diffuse lithium ions so as to reach the electrode active material close to a current collector. Therefore, supply of lithium ions from the electrolyte layer cannot keep up with the reduction to an extent that lithium ions are exhausted, and the performance (battery life and/or output characteristics) of the power storage device declines.

Thereupon, in order to raise the performance (battery life and/or output characteristics) of a power storage device, a power storage device has been proposed in which a concentration gradient is provided to make the concentration of solid contents other than the electrolyte become greater from the surface of an electrode active material layer of the power storage device toward the side of a current collector, and voids among the solid contents other than the electrolyte of the electrode active material layer are filled up with the electrolyte. This power storage device is characterized by having a distribution in porosity within the electrode (see, for example, Japanese Patent Publication No. 4055671).

However, in the above electrode, in order to enable discharging at a high current rate, the concentration gradient is provided for a gel electrolyte salt. This technology is only effective in an electrode of a power storage device using a gel electrolyte, and cannot be applied to an electrode of a power storage device using electrolytic solution. Therefore, it cannot contribute to raising the performance (battery life and/or output characteristics) of a power storage device using electrolytic solution.

### SUMMARY OF THE INVENTION

According to an embodiment, an electrode for an anode or a cathode of a power storage device, includes: an electrode current collector; and a plurality of electrode material layers stacked on one side of the electrode current collector, and configured to store and discharge lithium ions. In a case where the electrode is to be used as the anode, each of the electrode material layers includes a first material and a second material that causes less deposit of the lithium ions on a surface of the anode than the first material, and the farther the electrode material layer is placed from the electrode current collector, the greater a ratio of a weight of the second material to a total weight of the first material and the second material becomes. In a case where the electrode is to be used as the cathode, each of the electrode material layers includes a third material and a fourth material that has a higher diffusibility with respect to lithium ions than the third material, and the farther the electrode material layer is placed from the electrode current collector, the less a ratio of a weight of the fourth material to a total weight of the third material and the fourth material becomes.

### BRIEF DESCRIPTION OF DRAWINGS

FIG. 1 is a cross-sectional view illustrating an example of a nonaqueous electrolytic power storage device according to a first embodiment;

FIGS. 2A-2C are diagrams illustrating a manufacturing process of a nonaqueous electrolytic power storage device according to the first embodiment;

FIG. 3 is a cross-sectional view illustrating an example of a nonaqueous electrolytic power storage device according to a second embodiment;

FIGS. 4A-4C are diagrams illustrating a manufacturing process of a nonaqueous electrolytic power storage device according to the second embodiment;

FIG. 5 is a cross-sectional view illustrating an example of a nonaqueous electrolytic power storage device according to a modified example 1 of the second embodiment;

FIG. 6 is a cross-sectional view illustrating an example of a nonaqueous electrolytic power storage device according to a modified example 2 of the second embodiment;

FIGS. 7A-7C are diagrams illustrating a manufacturing process of a nonaqueous electrolytic power storage device according to the modified example 2 of the second embodiment;

FIG. 8 is a cross-sectional view illustrating an example of a nonaqueous electrolytic power storage device according to a third embodiment;

FIGS. 9A-9C are diagrams illustrating a manufacturing process of a nonaqueous electrolytic power storage device according to the third embodiment; and

FIG. 10 is a cross-sectional view illustrating an example of a nonaqueous electrolytic power storage device according to a modified example of the third embodiment.

### DETAILED DESCRIPTION OF THE EMBODIMENTS

In the following, embodiments will be described with reference to the drawings. Throughout the drawings, the same elements may be assigned the same reference symbols, and duplicated description may be omitted.

According to the disclosed technology, it is possible to provide an electrode that enables to raise the performance of a power storage device using electrolytic solution.

### First Embodiment

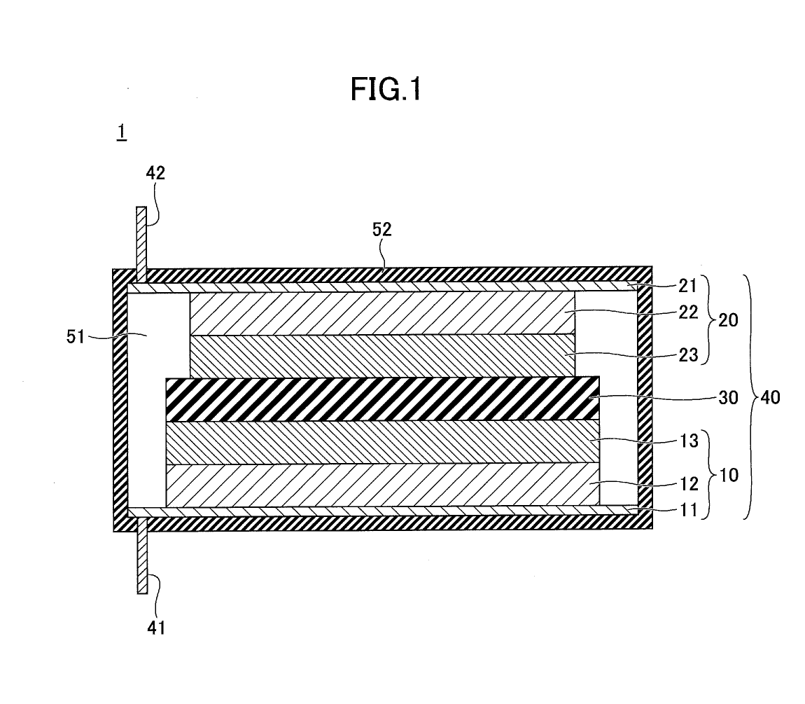

FIG. 1 is a cross-sectional view illustrating an example of a nonaqueous electrolytic power storage device according to a first embodiment. Referring to FIG. 1, a nonaqueous electrolytic power storage device 1 has structure in which nonaqueous electrolytic solution 51 is injected into an electrode element 40, and is sealed by an exterior 52. The nonaqueous electrolytic power storage device 1 may include other members as necessary. The nonaqueous electrolytic power storage device 1 is not limited in particular and can be selected properly depending on the purpose; for example, a nonaqueous electrolytic solution secondary battery, a nonaqueous electrolytic solution capacitor, and the like may be listed.

The electrode element 40 has a stacked structure in which an anode 10 having anode material layers 12 and 13 stacked in this order over an anode current collector 11, and a cathode 20 having cathode material layers 22 and 23 stacked in this order over a cathode current collector 21, are stacked via a separator 30, and the anode current collector 11 and the cathode current collector 21 face outward, respectively. An anode lead wire 41 is connected to the anode current collector 11, and is pulled out of the exterior 52. A cathode lead wire 42 is connected to the cathode current collector 21, and is pulled out of the exterior 52.

Note that in the electrode element 40, the surface areas of the principal surfaces of the anode material layers 12 and 13 are larger than the surface areas of the principal surfaces of the cathode material layers 22 and 23, respectively. This is for having the anode material layers 12 and 13 to securely receive lithium ions coming out of the cathode material layers 22 and 23. Here, the “principal surface” is a surface approximately perpendicular to the stacking direction.

The shape of the nonaqueous electrolytic power storage device 1 is not limited in particular and can be selected properly from among various shapes generally adopted depending on the application. Possible shapes may include, for example, a laminated type; a cylinder type in which a sheet electrode and a separator are formed to have a spiral shape; a cylinder having an inside-out structure in which a pellet electrode is combined with a separator; and a coin type in which a pellet electrode and a separator are stacked.

In the following, the nonaqueous electrolytic power storage device 1 will be described in detail. Note that in the present embodiment, for convenience' sake, a side of the nonaqueous electrolytic power storage device 1 where the cathode current collector 21 is located will be referred to as the “one surface side” or the “upper side”, and the other side where the anode current collector 11 is located will be referred to as the “other surface side” or the “lower side”. Also, a side of each member where the cathode current collector 21 is located will be referred to as the “one surface side” or the “upper side”, and the other side where the anode current collector 11 is located will be referred to as the “other surface side” or the “lower side”. However, the nonaqueous electrolytic power storage device 1 can be used in an upside-down state, and can be placed tilted at any angle. Also, an anode current collector and a cathode current collector may be collectively referred to as an “electrode current collector”, and an anode material layer and a cathode material layer may be collectively referred to as an “electrode material layer”. The other embodiments follow these.

<Anode>

The anode 10 is not limited in particular and can be selected properly depending on the purpose as long as an anode active material is included. In the present embodiment, the anode 10 has a structure in which the anode material layers 12 and 13 are stacked in this order over the anode current collector 11. The shape of the anode 10 is not limited in particular and can be selected properly depending on the purpose; for example, a flat shape may be considered.

<<Anode Current Collector>>

The material, shape, size, and structure of the anode current collector 11 are not limited in particular and can be selected properly depending on the purpose.

The material of the anode current collector 11 is not limited in particular and can be selected properly depending on the purpose as long as being formed of a conductive material; for example, stainless steel, nickel, aluminum, and copper may be listed. Among these, stainless steel and copper are especially favorable.

The shape of the anode current collector 11 is not limited in particular and can be selected properly depending on the purpose. The size of the anode current collector 11 is not limited in particular and can be selected properly depending on the purpose as long as being a usable size in the nonaqueous electrolytic power storage device 1.

<<Anode Material Layer>>

The anode material layers 12 and 13 are not limited in particular and can be selected properly depending on the purpose; for example, the layer includes at least an anode active material, and may include a binder and a conducting agent when necessary.

The average thickness of each of the anode material layers 12 and 13 is not limited in particular and can be selected properly depending on the purpose. The total average thickness of the anode material layers 12 and 13 is favorably greater than or equal to 10 μm and less than or equal to 450 μm, and is more favorably greater than or equal to 20 μm and less than or equal to 100 μm. If the total average thickness of the anode material layers 12 and 13 is less than or equal to 10 μm, the energy density may decline, and if it exceeds 450 μm, the cycle characteristic may degrade.

—Anode Active Material—

An anode active material contained in the anode material layers 12 and 13 is not limited in particular and can be selected properly depending on the purpose as long as being a substance capable of storing and discharging lithium ions. In the present embodiment, anode active materials contained in the anode material layers 12 and 13 include a first material and a second material that causes less deposit of lithium ions on the surface of the anode 10 than the first material. For example, a carbonaceous material is used as the principal material (the first material), and another carbonaceous material is added as the second material. Note that the “surface of the anode 10” on which lithium ions deposit is specifically a part of the interface between the anode material layer 13 and the separator 30.

As the carbonaceous material, various materials may be listed, for example, coke, graphite including artificial graphite and natural graphite, a pyrolysate of an organic matter in various pyrolysis conditions, amorphous carbon, and the like. Among these, artificial graphite, natural graphite, and amorphous carbon are especially favorable.

As anode active materials contained in the anode material layers 12 and 13, for example, artificial graphite or natural graphite may be used as the principal material (the first material), and amorphous carbon may be added as an additive (the second material).

Also, in the present embodiment, the anode material layer 12 and the anode material layer 13 are formed so that the concentration of the additive to the principal material (the ratio of the weight of the second material to the total weight of the first material and the second material) is different from each other.

Specifically, an anode material layer placed farther from the anode current collector 11 is formed to have a higher concentration of the additive with respect to the principal material (to have a greater ratio of the weight of the second material to the total weight of the first material and the second material). In other words, the anode material layer 13 farther from the anode current collector 11 (closer to the separator 30) has a higher concentration of the additive than the anode material layer 12 closer to the anode current collector 11.

For example, in the case of using artificial graphite or natural graphite as the principal material and amorphous carbon as the additive, the anode material layer 13 farther from the anode current collector 11 (closer to the separator 30) has a higher concentration of amorphous carbon than the anode material layer 12 closer to the anode current collector 11.

Note that in the present embodiment, although an example is described in which two layers of anode material layers are stacked over the anode current collector 11, three or more layers of anode material layers may be stacked over the anode current collector 11. In this case, an anode material layer closest to the anode current collector 11 is formed to have the lowest concentration of the additive, and each of the other anode material layers is formed to have a higher concentration of the additive such that the concentration becomes higher when approaching the most distant anode material layer from the anode current collector 11 (closest to the separator 30).

In this way, in the present embodiment, multiple anode material layers are stacked over the anode current collector 11 in which an anode material layer closest to the anode current collector 11 is formed to have the lowest concentration of the additive, and each of the other anode material layers is formed to have a higher concentration of the additive such that the concentration becomes higher when approaching the most distant anode material layer from the anode current collector 11 (closest to the separator 30).

In other words, the concentration of the additive to the principal material is gradually increased from the side of the anode current collector 11 toward the side of the separator 30 so that the effect of preventing deposit of lithium ions becomes greater from the side of the anode current collector 11 toward the side of the separator 30.

This enables to prevent lithium ions from depositing on the surface of the anode 10 while maintaining the performance of the nonaqueous electrolytic power storage device 1. Consequently, it is possible to prolong the life of the nonaqueous electrolytic power storage device 1.

Note that in order to prevent lithium ions from depositing on the surface of the anode 10, another method may be considered that forms the anode material layer 12 on the side of the anode current collector 11 from graphite, and forms the anode material layer 13 on the side of the separator 30 from amorphous carbon that has a greater effect of preventing deposit of lithium ions. However, this method is not favorable because stacking layers that are formed of different materials generate a voltage difference between the layers.

In the present embodiment, instead of stacking layers that are formed of different materials, the same materials are used in the layers, and the material ratios in the respective layers are changed so as to prevent lithium ions from depositing. This method is suitable in terms of no voltage difference generated between the layers.

—Binder—

A binder contained in the anode material layers 12 and 13 is not limited in particular and can be selected properly depending on the purpose; for example, fluorine-based binders such as polyvinylidene fluoride (PVDF) and polytetrafluoroethylene (PTFE), ethylene-propylene-butadiene rubber (EPBR), styrene-butadiene rubber (SBR), polyisoprene rubber, carboxymethyl cellulose (CMC), and the like may be listed.

Among these, one material may be used alone, or two or more may be used together. Among these, fluorine-based binders such as polyvinylidene fluoride (PVDF) and polytetrafluoroethylene (PTFE), carboxymethyl cellulose (CMC), and styrene-butadiene rubber (SBR) are favorable; PVDF and SBR are especially favorable compared with the other binders from the viewpoint of increasing the number of times of repeated charging and discharging.

As a conducting agent contained in the anode material layers 12 and 13, for example, metal materials such as copper and aluminum, carbonaceous materials such as carbon black and acetylene black, and the like are listed. Among these, one material may be used alone, or two or more may be used together.

<Cathode>

The cathode 20 is not limited in particular and can be selected properly depending on the purpose as long as a cathode active material is included. In the present embodiment, the cathode 20 has a structure in which the cathode material layers 22 and 23 are stacked in this order over the cathode current collector 21. The shape of the cathode 20 is not limited in particular and can be selected properly depending on the purpose; for example, a flat shape may be considered.

<<Cathode Current Collector>>

The material, shape, size, and structure of the cathode current collector 21 are not limited in particular and can be selected properly depending on the purpose.

The material of the cathode current collector 21 is not limited in particular and can be selected properly depending on the purpose as long as being formed of a conductive material; for example, stainless steel, nickel, aluminum, and copper may be listed. Among these, stainless steel and copper are especially favorable. The shape of the cathode current collector 21 is not limited in particular and can be selected properly depending on the purpose. The size of the cathode current collector 21 is not limited in particular and can be selected properly depending on the purpose as long as being a usable size in the nonaqueous electrolytic power storage device 1.

<<Cathode Material Layer>>

The cathode material layers 22 and 23 are not limited in particular and can be selected properly depending on the purpose; for example, the layer includes at least a cathode active material, and may include a binder, a thickener, and a conducting agent when necessary.

The average thickness of each of the cathode material layers 22 and 23 is not limited in particular and can be selected properly depending on the purpose. The total average thickness of the cathode material layers 22 and 23 is favorably greater than or equal to 10 μm and less than or equal to 300 μm, and is more favorably greater than or equal to 40 μm and less than or equal to 150 μm. If the total average thickness of the cathode material layers 22 and 23 is less than or equal to 20 μm, the energy density may decline, and if it exceeds 300 μm, the load characteristic may degrade.

—Cathode Active Material—

A cathode active material contained in the cathode material layers 22 and 23 is not limited in particular and can be selected properly depending on the purpose as long as being a substance capable of storing and discharging lithium ions. In the present embodiment, cathode active materials contained in the cathode material layers 22 and 23 include a third material and a fourth material having a higher diffusibility of lithium ions (accelerating diffusion of lithium ions more) than the third material. For example, as the principal material, a third material may be selected that is capable of enlarging the capacity of the nonaqueous electrolytic power storage device 1, to which a fourth material is added that has a higher diffusibility of lithium ions. Note that if the ratio of the fourth material having a higher diffusibility of lithium ions, it is possible to improve the output of the nonaqueous electrolytic power storage device 1.

For example, a material can be used that contains a lithium-nickel compound oxide as the principal material (the third material), which may be LiNi_{X}Co_{Y}Mn_{Z}O₂ (where X+Y+Z=1), and also contains as an additive (the fourth material) a lithium phosphate-based material having the basic skeleton of spinel manganese or Li_{X}Me_{y}(PO4)_{Z} (where 0.5≤X≤4, Me=transition metal, 0.5≤Y≤2.5, and 0.5≤Z≤3.5).

Also, another material may be used that contains a lithium-nickel compound oxide as the principal material (the third material), which may be LiNi_{X}Co_{Y}Mn_{Z}O₂ (where X+Y+Z=1), and also contains as an additive (the fourth material) another lithium-nickel compound oxide having a smaller particle diameter than the principal material.

In this case, the average particle diameter of the principal material is favorably, for example, approximately 5 to 10 μm, and the average particle diameter of the additive is favorably, for example, approximately 1 to 8 μm. Here, the “average particle diameter” means a diameter at which greater particles and smaller particles are balanced in terms of the aggregated volume where the volume is obtained from a measurement result of volume distribution (or particle size distribution) of the particles. Such a measurement can be performed by using, for example, a particle size analyzer using a laser diffraction and scattering method.

As a lithium-nickel compound oxide conforming to LiNi_{X}CoyMn_{z}O₂ (where X+Y+Z=1), for example, LiNi_{0.33}Co_{0.33}Mn_{0.33}O₂, LiNi_{0.5}Co_{0.2}Mn_{0.3}O₂, LiNi_{0.6}Co_{0.2}Mn_{0.2}O₂, LiNi_{0.8}Co_{0.2}Mn₀O₂, and the like may be listed.

As a lithium phosphate based material having the basic skeleton of spinel manganese or Li_{X}Me_{Y}(PO₄)_{Z} (where 0.5≤X≤4, Me=transition metal, 0.5≤Y≤2.5, and 0.5≤Z≤3.5), for example, lithium-vanadium phosphate (Li₃V₂(PO₄)₃), olivine iron (LiFePO₄), olivine manganese (LiMnPO₄), olivine cobalt (LiCoPO₄), olivine nickel (LiNiPO₄), olivine vanadium (LiVOPO₄), a similar compound containing one of these as the basic skeleton and having an element of different species doped, and the like may be listed.

Also, in the present embodiment, the cathode material layer 22 and the cathode material layer 23 are formed so that the concentration of the additive to the principal material (the ratio of the weight of the fourth material to the total weight of the third material and the fourth material) is different from each other.

Specifically, a cathode material layer placed farther from the cathode current collector 21 is formed to have a lower concentration of the additive with respect to the principal material (to have a smaller ratio of the weight of the fourth material to the total weight of the third material and the fourth material).

In other words, in the cathode material layer 22 closer to the cathode current collector 21, the ion diffusibility is prioritized over the capacity, and the concentration of the additive is set so as to make the ion diffusibility better. On the other hand, in the cathode material layer 23 farther from the cathode current collector 21 (closer to the separator 30), the capacity is prioritized over the ion diffusibility, and the concentration of the additive is set so as to make the capacity greater.

For example, in the case of using a lithium-nickel compound oxide as the principal material and spinel manganese as the additive, the cathode material layer 22 closer to the cathode current collector 21 is to have a higher concentration of spinel manganese than the cathode material layer 23 to improve the ion diffusibility. On the other hand, the cathode material layer 23 farther from the cathode current collector 21, the concentration of added spinel manganese is lower than in the cathode material layer 22 to make the capacity greater.

In the case of using a lithium-nickel compound oxide as the principal material and lithium vanadium phosphate as the additive, the cathode material layer 22 closer to the cathode current collector 21 is to have a higher concentration of lithium vanadium phosphate than the cathode material layer 23 to improve the ion diffusibility. On the other hand, the cathode material layer 23 farther from the cathode current collector 21, the concentration of added lithium vanadium phosphate is lower than in the cathode material layer 22 to make the capacity greater.

In the case of using a lithium-nickel compound oxide as the principal material and another lithium-nickel compound oxide having a smaller particle diameter than the principal material as the additive, the cathode material layer 22 closer to the cathode current collector 21 is to have a higher concentration of the other lithium-nickel compound oxide having the smaller particle diameter than the principal material, than the cathode material layer 23 to improve the ion diffusibility. On the other hand, the cathode material layer 23 farther from the cathode current collector 21, the concentration of the other lithium-nickel compound oxide having the smaller particle diameter than the principal material is lower than in the cathode material layer 22 to make the capacity greater.

Note that in the present embodiment, although an example will be described in which two layers of cathode material layers are stacked over the cathode current collector 21, three or more layers of cathode material layers may be stacked over the cathode current collector 21. In this case, a cathode material layer closest to the cathode current collector 21 is formed to have the highest ion diffusibility, and each of the other cathode material layers is formed to have a lower ion diffusibility such that the ion diffusibility becomes lower when approaching the most distant cathode material layer from the cathode current collector 21 (closest to the separator 30).

In this way, in the present embodiment, multiple cathode material layers are stacked over the cathode current collector 21 in which a cathode material layer closest to the cathode current collector 21 is formed to have the highest ion diffusibility, and each of the other cathode material layers is formed to have a lower concentration of the additive when approaching the most distant cathode material layer from the cathode current collector 21 (closest to the separator 30) so that the ion diffusibility becomes lower and the capacity becomes greater.

In other words, the concentration of the additive to the principal material is gradually decreased in the layers from the side of the cathode current collector 21 toward the side of the separator 30 so as to decrease the ion diffusibility and to increase the capacity from the side of the cathode current collector 21 toward the side of the separator 30.

This enables to improve the capacity of the nonaqueous electrolytic power storage device 1, to accelerate diffusion of lithium ions within the nonaqueous electrolytic power storage device 1, and thereby, to improve the output performance.

Note that in order to improve the capacity of the nonaqueous electrolytic power storage device 1, to accelerate diffusion of lithium ions within the nonaqueous electrolytic power storage device 1, and thereby, to improve the output performance, another method may be considered that forms the cathode material layer 22 on the side of the cathode current collector 21, from a material that accelerates diffusion of lithium ions, and forms the cathode material layer 23 on the side of the separator 30, from a material that can make the capacity of the nonaqueous electrolytic power storage device 1 greater. However, this method is not favorable because stacking layers that are formed of different materials generate voltage differences between the layers.

In the present embodiment, instead of stacking layers that are formed of different materials, the same materials are used in the layers, and the material ratios in the respective layers are changed so as to make the capacity of the nonaqueous electrolytic power storage device 1 greater, and to accelerate diffusion of lithium ions within the nonaqueous electrolytic power storage device 1, and thereby, to improve the output performance. This method is suitable in terms of no voltage difference generated between the layers.

—Binder—

A binder contained in the cathode material layers 22 and 23 is not limited in particular and can be selected properly depending on the purpose as long as being a stable material with respect to solvent or electrolytic solution to be used when the electrode is manufactured; for example, fluorine-based binders such as polyvinylidene fluoride (PVDF) and polytetrafluoroethylene (PTFE), ethylene-propylene-butadiene rubber (EPBR), styrene-butadiene rubber (SBR), polyisoprene rubber, and the like may be listed. Among these, one material may be used alone, or two or more may be used together.

—Thickener—

A thickener contained in the cathode material layers 22 and 23 may be, for example, carboxymethylcellulose (CMC), methyl cellulose, hydroxymethyl cellulose, ethyl cellulose, polyvinyl alcohol, starch oxide, starch phosphate, casein, or the like. Among these, one material may be used alone, or two or more may be used together. Note that the thickener may not be used.

—Conducting Agent—

As a conducting agent contained in the cathode material layers 22 and 23, for example, metal materials such as copper and aluminum, carbonaceous materials such as carbon black and acetylene black, and the like are listed. Among these, one material may be used alone, or two or more may be used together.

<Nonaqueous Electrolytic Solution>

The nonaqueous electrolytic solution 51 is an electrolytic solution containing a nonaqueous solvent and an electrolyte salt.

<<Nonaqueous Solvent>>

The nonaqueous solvent is not limited in particular and can be selected properly depending on the purpose; for example, an aprotic organic solvent is suitable. As an aprotic organic solvent, a carbonate-based organic solvent, such as a chain carbonate or a cyclic carbonate, may be used. As a chain carbonate, for example, dimethyl carbonate (DMC), diethyl carbonate (DEC), methyl ethyl carbonate (MEC), methyl propionate (MP), and the like may be listed.

As a cyclic carbonate, for example, propylene carbonate (PC), ethylene carbonate (EC), butylene carbonate (BC), vinylene carbonate (VC), and the like may be listed.

In the case of using mixed solvent combining ethylene carbonate (EC) as a cyclic carbonate with dimethyl carbonate (DMC) as a chain carbonate, the mixing ratio of ethylene carbonate (EC) and dimethyl carbonate (DMC) is not limited in particular and can be selected properly depending on the purpose.

Note that as a nonaqueous solvent, it is possible to use an ester-based organic solvent such as such as a cyclic ester or a chain ester, an ether-based organic solvent such as a cyclic ether or a chain ether, or the like when necessary.

As a cyclic ester, for example, γ-butyrolactone (γBL), 2-methyl-γ-butyrolactone, acetyl-γ-butyrolactone, γ-valerolactone, and the like may be listed.

As a chain ester, for example, propionic acid alkyl ester, malonic acid dialkyl ester, alkyl ester acetate (methyl acetate (MA), ethyl acetate, etc.), alkyl ester formate (methyl formate (MF), ethyl formate, etc.), and the like may be listed.

As a cyclic ether, for example, tetrahydrofuran, alkyltetrahydrofuran, alkoxytetrahydrofuran, dialkoxytetrahydrofuran, 1,3-dioxolane, alkyl-1,3-dioxolane, 1,4-dioxolane, and the like may be listed.

As a chain ether, for example, 1,2-dimethoxyethane (DME), diethyl ether, ethylene glycol dialkyl ether, diethylene glycol dialkyl ether, triethylene glycol dialkyl ether, tetraethylene glycol dialkyl ether, and the like may be listed.

<<Electrolyte Salt>>

As an electrolyte salt, a lithium salt may be used. The lithium salt is not limited in particular and can be selected properly depending on the purpose; for example, lithium hexafluorophosphate (LiPF₆), lithium perchlorate (LiClO₄), lithium chloride (LiCl), lithium borofluoride (LiBF₄), lithium hexafluoroarsenate (LiAsF₆), lithium trifluoromethanesulfonate (LiCF₃SO₃), lithium bis(trifluoromethylsulfonyl)imide (LiN(C₂F₅SO₂)₂), lithium bis(perfluoroethylsulfonyl)imide (LiN(CF₂F₅SO₂)₂), and the like may be listed. Among these, one material may be used alone, or two or more may be used together. Among these, from the viewpoint of the capacity of anions stored in a carbon electrode, LiPF₆ is especially favorable.

The content of an electrolyte salt is not limited in particular and can be selected properly depending on the purpose. The content in a nonaqueous solvent is favorably greater than or equal to 0.7 mol/L and less than or equal to 4 mol/L; more favorably greater than or equal to 1.0 mol/L and less than or equal to 3 mol/L; and further favorably greater than or equal to 1.0 mol/L and less than or equal to 2.5 mol/L from the viewpoint of compatibility of the capacity and the output of a power storage device.

<Separator>

The separator 30 is provided between the anode 10 and the cathode 20, in order to prevent a short circuit between the anode 10 and the cathode 20. The separator 30 is an insulating layer that has a permeability of lithium ions and no electron conductivity. The material, shape, size, and structure of the separator 30 are not limited in particular and can be selected properly depending on the purpose.

As the material of the separator 30, for example, paper such as kraft paper, vinylon mixed paper, and synthetic pulp mixed paper; cellophane; a polyethylene graft film; polyolefin nonwoven fabric such as polypropylene melt flow nonwoven fabric; polyamide nonwoven fabric; glass fiber nonwoven fabric; a polyethylene-based fine porous film; a polypropylene-based fine porous film; and the like may be listed. Among these, from the viewpoint of storing the nonaqueous electrolytic solution 51, a material having the porosity greater than or equal to 50% is favorable.

As the separator 30, for example, a material made of fine particles of ceramics, such as alumina and zirconia, mixed with a binder or solvent, may be used. In this case, the average particle diameter of fine particles of ceramics is favorably, for example, approximately 0.2 to 3.0 μm. This enables to provide permeability of lithium ions. Here, the meaning of “average particle diameter” and a measuring method of the average particle diameter are as described above.

The average thickness of the separator 30 is not limited in particular and can be selected properly depending on the purpose. It is favorable to be greater than or equal to 3 μm and less than or equal to 50 μm, and it is more favorable to be greater than or equal to 5 μm and less than or equal to 30 μm.

If the average thickness of the separator 30 is greater than or equal to 3 μm, it is possible to securely prevent a short circuit between the anode 10 and the cathode 20. Also, if the average thickness of the separator 30 is less than or equal to 50 μm, it is possible to prevent the electrical resistance between the anode 10 and the cathode 20 from increasing due to a significant separation between the anode 10 and the cathode 20.

If the average thickness of the separator 30 is greater than or equal to 5 μm, it is possible to further securely prevent a short circuit between the anode 10 and the cathode 20. Also, if the average thickness of the separator 30 is less than or equal to 30 μm, it is possible to firmly prevent the electrical resistance between the anode 10 and the cathode 20 from increasing due to a significant separation between the anode 10 and the cathode 20.

As the shape of the separator 30, for example, a sheet-like shape may be considered. The size of the separator 30 is not limited in particular and can be selected properly depending on the purpose as long as being a usable size in the nonaqueous electrolytic power storage device 1. The structure of the separator 30 may be a monolayer structure or may be a stacked layer structure.

<Manufacturing Method of Nonaqueous Electrolytic Power Storage Device>

—Production of Anode and Separator—

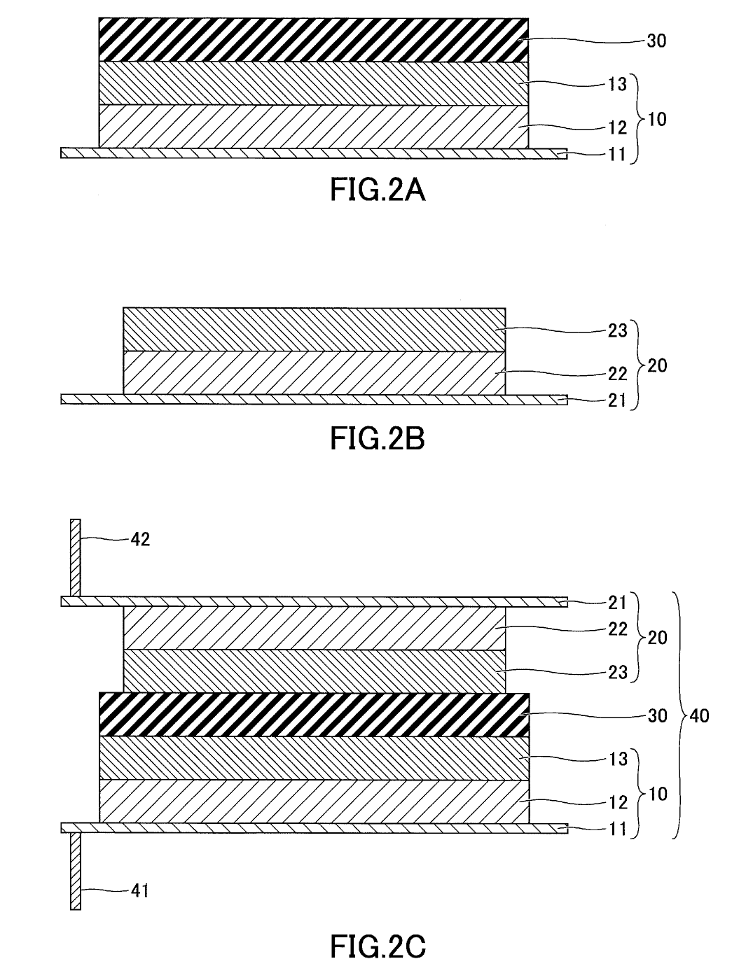

First, an anode 10 and a separator 30 are produced as illustrated in FIG. 2A. Specifically, an anode current collector 11 is prepared, which is formed of stainless steel, copper, or the like. Then, when necessary, a binder, a conducting agent, solvent, and the like are added to an anode active material to produce slurry of an anode material composite for an anode material layer 12, which is applied on the anode current collector 11, and dried to form the anode material layer 12. The anode current collector 11 and the anode material layer 12 bond together.

Next, slurry of an anode material composite for an anode material layer 13 having a binder, a conducting agent, solvent, and the like added when necessary is produced by changing the concentration of the additive with respect to the principal material, which is applied to the anode current collector 12, and dried to form the anode material layer 13. The anode material layer 12 and the anode material layer 13 bond together.

Next, slurry of a composite for the separator 30 is produced by mixing fine particles of ceramics, such as alumina and zirconia, with a binder or solvent, which is applied on the anode material layer 13, and dried to form the separator 30. The anode material layer 13 and the separator 30 bond together.

When applying the anode material composite or the composite for the separator 30, for example, an inkjet method may be used, but it is not limited as such; another method can be selected properly depending on the purpose, such as a comma coater, a gravure coater, screen printing, dry press coating, and a dispenser method.

Note that an inkjet method is suitable for applying a coating material at a targeting point on a lower layer. An inkjet method is also suitable for bonding upper and lower surfaces of the anode current collector 11, the anode material layer 12, and the anode material layer 13 that contact each other. An inkjet method is also suitable for making the thickness of each of the layers uniform.

The solvent is not limited in particular and can be selected properly depending on the purpose; for example, an aqueous solvent, an organic solvent, and the like may be listed. As an aqueous solvent, for example, water, alcohol, and the like may be listed. As an organic solvent, for example, N-methyl-2-pyrrolidone (NMP), toluene, and the like may be listed.

Alternatively, a sheet electrode may be formed by performing roll forming directly on an anode active material having a binder, a conducting agent, and the like added; a pellet electrode may be formed by performing compression molding; or a thin film of the anode active material may be formed on the anode current collector 11 by a method such as vapor deposition, sputtering, or plating.

—Production of Cathode—

Next, a cathode 20 is produced as illustrated in FIG. 2B. Specifically, a cathode current collector 21 is prepared, which is formed of stainless steel, copper, or the like. Then, when necessary, a binder, a thickener, a conducting agent, solvent, and the like are added to a cathode active material to produce slurry of a cathode material composite for a cathode material layer 22, which is applied on the cathode current collector 21, and dried to form the cathode material layer 22. The cathode current collector 21 and the cathode material layer 22 bond together.

Next, slurry of a cathode material composite for a cathode material layer 23 having a binder, a thickener, a conducting agent, solvent, and the like added when necessary is produced by changing the concentration of the additive with respect to the principal material, which is applied on the cathode material layer 22, and dried to form the cathode material layer 23. The cathode material layer 22 and the cathode material layer 23 bond together.

When applying the cathode material composite, for example, an inkjet method may be used, but it is not limited as such; another method can be selected properly depending on the purpose, such as a comma coater, a gravure coater, screen printing, dry press coating, and a dispenser method.

As a solvent, substantially the same solvent may be used as in the manufacturing method of the anode 10. Also, a sheet electrode may be formed by performing roll forming directly on a cathode active material, and a pellet electrode may be formed by performing compression molding.

—Production of Electrode Element and Nonaqueous Electrolytic Power Storage Device—

Next, an electrode element 40 is produced as illustrated in FIG. 2C. Specifically, first, an anode lead wire 41 is joined to the anode current collector 11 by welding or the like. Also, a cathode lead wire 42 is joined to the cathode current collector 21 by welding or the like. Then, the cathode 20 is placed over the anode 10 so that the anode material layer 13 of the anode 10 and the cathode material layer 23 of the cathode 20 face each other through the separator 30, to produce the electrode element 40.

After having completed the process illustrated in FIG. 2C, the nonaqueous electrolytic solution 51 is injected into the electrode element 40, and is sealed by the exterior 52, to complete the nonaqueous electrolytic power storage device 1 illustrated in FIG. 1.

In this way, according to the present embodiment, it is possible to raise the performances (life, output characteristic, etc.) of the nonaqueous electrolytic power storage device 1.

In other words, the concentration of the additive to the principal material is gradually increased from the side of the anode current collector 11 toward the side of the separator 30 so that the effect of preventing deposit of lithium ions becomes greater from the side of the anode current collector 11 toward the side of the separator 30. This enables to prevent lithium ions from depositing on the surface of the anode 10 while maintaining the performance of the nonaqueous electrolytic power storage device 1. Consequently, it is possible to prolong the life of the nonaqueous electrolytic power storage device 1.

Also, the concentration of the additive to the principal material is gradually decreased in the layers from the side of the cathode current collector 21 toward the side of the separator 30 so as to decrease the ion diffusibility and to increase the capacity from the side of the cathode current collector 21 toward the side of the separator 30. This enables to improve the capacity of the nonaqueous electrolytic power storage device 1, to accelerate diffusion of lithium ions within the nonaqueous electrolytic power storage device 1, and thereby, to improve the output performance.

Also, in the case of using an inkjet method, layers can be easily stacked. Therefore, the manufacturing process can be simplified and the production time can be shortened.

Note that in the method illustrated in FIG. 2, although the separator 30 and the cathode material layer 23 do not bond together, a binder or the like may be sandwiched between the separator 30 and the cathode material layer 23, to bond the separator 30 and the cathode material layer 23 together. In this case, no relative position gap between the anode material layer and the cathode material layer is produced between electrode current collectors next to each other.

This enables to prevent lithium ions from depositing on the surface of the anode due to a relative position gap between the anode material layer and the cathode material layer, which could be generated by vibration and/or bending. Consequently, it is possible to prolong the life of the nonaqueous electrolytic power storage device 1. Also, it is possible to obtain a stable output at all the time.

It is also possible to prevent a short circuit between the anode and the cathode due to a relative position gap between the anode material layer and the cathode material layer, which could be generated by vibration and/or bending. This improves the safety of the nonaqueous electrolytic power storage device 1. Consequently, the nonaqueous electrolytic power storage device 1 can be suitably used in a device in which vibration and bending are likely to occur, such as a wearable device, a mobile device, and a robot.

Note that although an example has been described in which the concentration of the additive is gradually changed in both layers of the anode 10 and layers of the cathode 20, the concentration of the additive may be gradually changed in either of the layers of the anode 10 or the layers of the cathode 20. In this case, the effects described above can be obtained in an electrode in which the concentration of the additive is gradually changed in the layers.

### Second Embodiment

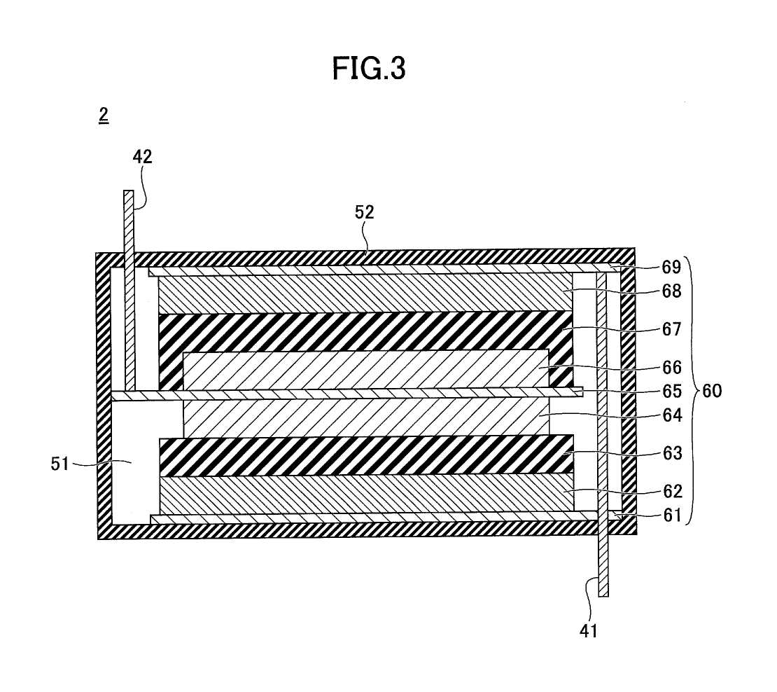

FIG. 3 is a cross-sectional view illustrating an example of a nonaqueous electrolytic power storage device according to a second embodiment. Referring to FIG. 3, a nonaqueous electrolytic power storage device 2 has a structure in which a nonaqueous electrolytic solution 51 is injected into an electrode element 60, and is sealed by an exterior 52. The nonaqueous electrolytic power storage device 2 may include other members as necessary. The nonaqueous electrolytic power storage device 2 is not limited in particular and can be selected properly depending on the purpose; for example, a nonaqueous electrolytic soliation secondary battery, and a nonaqueous electrolytic solution capacitor, and the like may be listed.

The electrode element 60 has a stacked structure in which an anode material layer 62, a separator 63, a cathode material layer 64, a cathode current collector 65, a cathode material layer 66, a separator 67, an anode material layer 68, and an anode current collector 69 are stacked in this order over an anode current collector 61. The anode current collector 61, the anode material layer 62, the separator 63, and the cathode material layer 64 are bonded together. Also, the cathode current collector 65, the cathode material layer 66, the separator 67, and the anode material layer 68 are bonded stacked.

The anode material layers 62 and 68 are electrode material layers for an anode, capable of storing and discharging lithium ions. The separators 63 and 67 are insulating layers that have permeability of lithium ions and no electron conductivity. The cathode material layers 64 and 66 are electrode material layers for a cathode, capable of storing and discharging lithium ions.

An anode lead wire 41 is connected to the anode current collectors 61 and 69, and is pulled out of the exterior 52. A cathode lead wire 42 is connected to the cathode current collector 65, and is pulled out of the exterior 52.

The material, thickness, and the like of the anode current collectors 61 and 69, and the cathode current collector 65 may be substantially the same as, for example, those of the anode current collector 11 and the cathode current collector 21.

The configuration of the anode material layers 62 and 68 may be substantially the same as, for example, that of the anode material layers 12 and 13. However, it is not necessary to add an additive to the anode active material, and materials that can be used as the anode active material include, for example, coke; graphite such as artificial graphite and natural graphite; pyrolysate of an organic matter obtained under various pyrolysis conditions; and carbon materials such as amorphous carbon.

However, each of the anode material layers 62 and 68 may be formed to have a stacked structure of multiple layers, and as in the first embodiment, the concentration of the additive to the principal material is increased gradually in the layered structure of the anode material layer 62 while the separation becomes greater from the side of the anode current collector 61; and in the stacked layer structure of the anode material layer 68, the concentration of the additive to the principal material is increased gradually in the layered structure of the anode material layer 68 while the separation becomes greater from the side of the anode current collector 69. This enables to bring substantially the same effects as in the first embodiment.

The configurations of the cathode material layers 64 and 66 may be substantially the same as, for example, those of the cathode material layers 22 and 23, respectively. However, it is not necessary to add an additive to the cathode active material, and as the cathode active material, for example, a lithium nickel compound oxide, spinel manganese, a lithium-phosphate-based material, and the like may be used.

However, each of the cathode material layers 64 and 66 may be formed to have a stacked structure of multiple layers, and as in the first embodiment, the concentration of the additive to the principal material may be decreased gradually in the layers while the separation becomes greater from the side of the cathode current collector 65. This enables to bring substantially the same effects as in the first embodiment.

As the separators 63 and 67, for example, it is possible to use fine particles of ceramics such as alumina, zirconia, and silica. In this case, the average particle diameter of fine particles of ceramics is favorably, for example, approximately 0.2 to 3.0 μm. This enables to provide permeability of lithium ions. Here, the meaning of “average particle diameter” and a measuring method of the average particle diameter are as described above. It is possible to use a material in which these ceramic fine particles are mixed with a binder or solvent described in the first embodiment. Using fine particles of ceramics enables to form the separators 63 and 67 on the respective lower layers by an inkjet method, and hence, the separators 63 and 67 can be bonded with the respective lower layers.

The average thickness of the separators 63 and 67 is not limited in particular and can be selected properly depending on the purpose. It is favorable to be greater than or equal to 0.5 μm and less than or equal to 15 μm, and more favorable to be greater than or equal to 1 μm and less than or equal to 10 μm. If the average thickness of the separators 63 and 67 is greater than or equal to 1 μm and less than or equal to 10 μm, it is possible to prevent a short circuit between the anode material layer 62 and the cathode material layer 64, and between the cathode material layer 66 and the anode material layer 68.

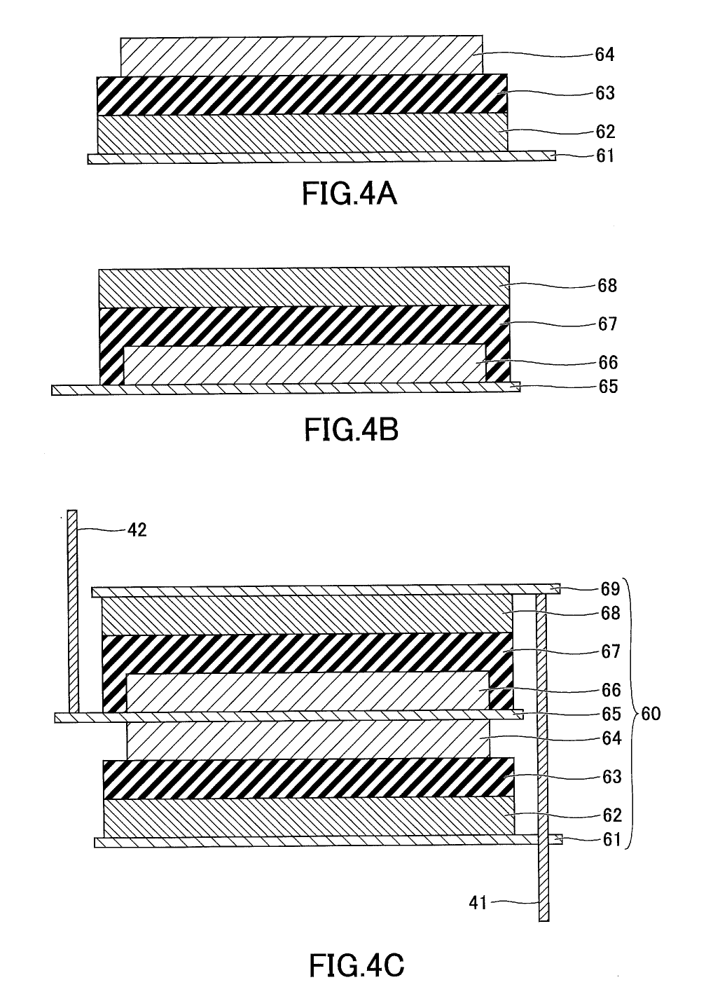

When producing a nonaqueous electrolytic power storage device 2, as illustrated in FIG. 4A, an anode material layer 62, a separator 63, and a cathode material layer 64 are stacked in this order over an anode current collector 61, as in the first embodiment. The anode current collector 61, the anode material layer 62, the separator 63, and the cathode material layer 64 bond together.

Next, as illustrated in FIG. 4B, a cathode material layer 66, a separator 67, and an anode material layer 68 are stacked in this order over a cathode current collector 65 as in the first embodiment. The cathode current collector 65, the cathode material layer 66, the separator 67, and the anode material layer 68 bond together.

Although production of the respective layers illustrated in FIG. 4A and FIG. 4B can be performed by any of the methods exemplified in the first embodiment, it is favorable to adopt an inkjet method that can bond layers next to each other. In the case of producing the layers by an inkjet method, after having applied slurry to the lower layer by the inkjet method, heating is performed up to a predetermined temperature to evaporate the solvent.

Next, as illustrated in FIG. 4C, the electrode element 60 is produced. Specifically, first, an anode lead wire 41 is joined to the anode current collectors 61 and 69 by welding or the like. Also, a cathode lead wire 42 is joined to the cathode current collector 65 by welding or the like. Then, over a stacked layer object composed of the anode current collector 61, the anode material layer 62, the separator 63, and the cathode material layer 64, another stacked layer object composed of the cathode current collector 65, the cathode material layer 66, the separator 67, and the anode material layer 68 is placed, and the anode current collector 69 is further placed over the anode material layer 68, to produce the electrode element 60.

Note that in this method, although the cathode material layer 64 and the cathode current collector 65 do not bond together, a binder or the like may be sandwiched between the cathode material layer 64 and the cathode current collector 65, to bond the cathode material layer 64 and the cathode current collector 65 together. Similarly, although the anode material layer 68 and the anode current collector 69 do not bond together, a binder or the like may be sandwiched between the anode material layer 68 and the anode current collector 69, to bond the anode material layer 68 and the anode current collector 69 together.

After having completed the process illustrated in FIG. 4C, the nonaqueous electrolytic solution 51 is injected into the electrode element 60, and is sealed by the exterior 52, to complete the nonaqueous electrolytic power storage device 2 illustrated in FIG. 3.

In this way, in the nonaqueous electrolytic power storage device 2, layers next to each other bond together in the anode current collector 61, the anode material layer 62, the separator 63, and the cathode material layer 64. Also, layers next to each other bond together in the cathode current collector 65, the cathode material layer 66, the separator 67, and the anode material layer 68. In other words, no relative position gap between the anode material layer and the cathode material layer is produced between electrode current collectors next to each other.

This enables to prevent lithium ions from depositing on the surface of the anode due to a relative position gap between the anode material layer and the cathode material layer, which could be generated by vibration and/or bending. Consequently, it is possible to prolong the life of the nonaqueous electrolytic power storage device 2. Also, it is possible to obtain a stable output at all the time.

It is also possible to prevent a short circuit between the anode and the cathode due to a relative position gap between the anode material layer and the cathode material layer, which could be generated by vibration and/or bending. This improves the safety of the nonaqueous electrolytic power storage device 2. Consequently, the nonaqueous electrolytic power storage device 2 can be suitably used in a device in which vibration and bending are likely to occur, such as a wearable device, a mobile device, and a robot.

Also, using an inkjet method enables to easily stack layers. Therefore, the manufacturing process can be simplified and the production time can be shortened.

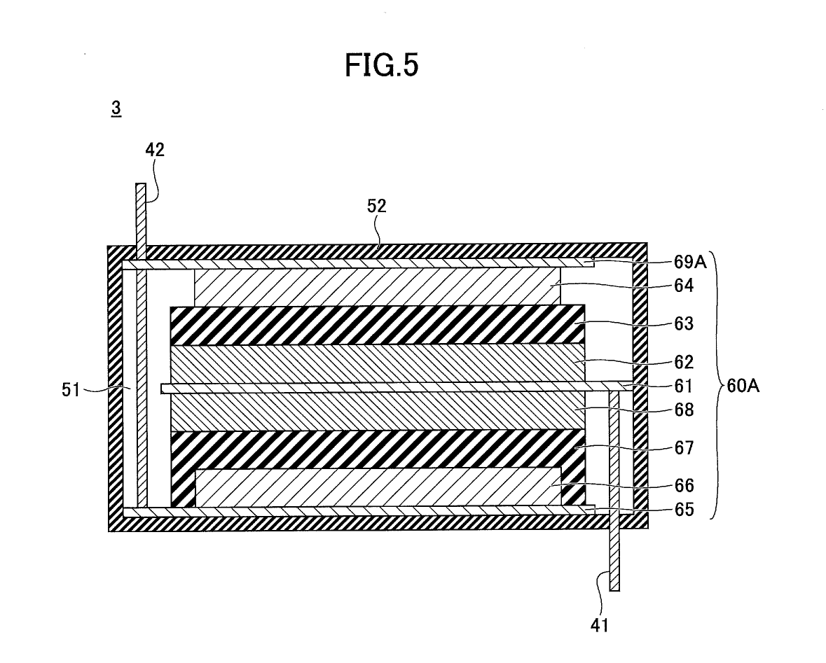

Note that the method may be modified as illustrated in FIG. 5. In a nonaqueous electrolytic power storage device 3 illustrated in FIG. 5, the electrode element 60 of the nonaqueous electrolytic power storage device 2 is replaced by an electrode element 60A.

The electrode element 60A has an order of stacked layers different from the order in the electrode element 60. That is, the electrode element 60A has a structure in which a cathode material layer 66, a separator 67, an anode material layer 68, an anode current collector 61, an anode material layer 62, a separator 63, a cathode material layer 64, and a cathode current collector 69A are stacked in this order over a cathode current collector 65. The anode current collector 61, the anode material layer 62, the separator 63, and the cathode material layer 64 are bonded together. Also, the cathode current collector 65, the cathode material layer 66, the separator 67, and the anode material layer 68 are bonded together.

An anode lead wire 41 is connected to the anode current collector 61, and is pulled out of the exterior 52. A cathode lead wire 42 is connected to the cathode current collectors 65 and 69A, and is pulled out of the exterior 52.

The nonaqueous electrolytic power storage device 3 may be produced by substantially the same method as the nonaqueous electrolytic power storage device 2. In the nonaqueous electrolytic power storage device 3, no relative position gap between the anode material layer and the cathode material layer is produced between electrode current collectors next to each other, as in the case of the nonaqueous electrolytic power storage device 2. Consequently, substantially the same effects can be obtained as with the nonaqueous electrolytic power storage device 2.

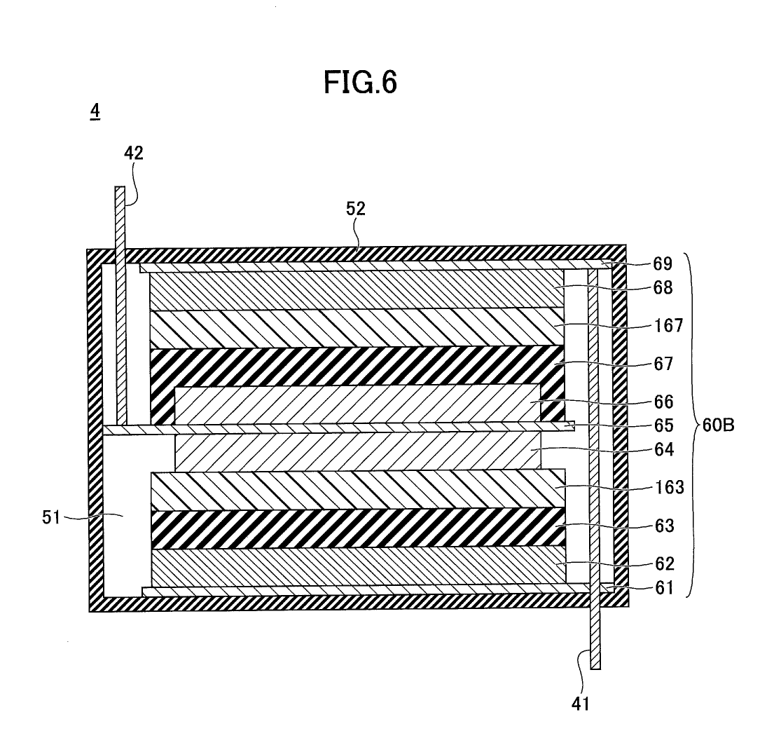

Also, the method may be modified as illustrated in FIG. 6. In a nonaqueous electrolytic power storage device 4 illustrated in FIG. 6, the electrode element 60 of the nonaqueous electrolytic power storage device 2 is replaced by an electrode element 60B.

In the electrode element 60B, a separator 163 is stacked between a separator 63 and a cathode material layer 64, and a separator 167 is stacked between a separator 67 and an anode material layer 68. Note that the separators 63 and 67 may be referred to as the “first separators”, and the separators 163 and 167 may be referred to as the “second separators”.

In the electrode element 60B, materials to be used as the separators 163 and 167 include, for example, polyvinylidene fluoride, polytetrafluoroethylene, polyacrylate, nylon 6 (registered trademark), nylon 66, polycarbonate, polyethylene terephthalate, polyethylene, polypropylene, polystyrene, acrylic, and resin materials such as phenol resin, melamine resin, epoxy resin, silicone resin, and polyurethane. Among these, from the viewpoint of storing the nonaqueous electrolytic solution 51, a material having the porosity greater than or equal to 50% is favorable.

The average thickness of the separators 163 and 167 is not limited in particular and can be selected properly depending on the purpose. It is favorable to be greater than or equal to 3 μm and less than or equal to 50 μm, and it is more favorable to be greater than or equal to 5 μm and less than or equal to 30 μm. If the average thickness of the separators 163 and 167 is greater than or equal to 5 μm, it is possible to further securely prevent a short circuit between the cathode material layer 66 and the anode material layer 68. Also, if the average thickness of the separators 163 and 167 is less than or equal to 30 μm, it is possible to firmly prevent the electrical resistance from increasing between the anode material layer 62 and the cathode material layer 64, and between the cathode material layer 66 and the anode material layer 68.

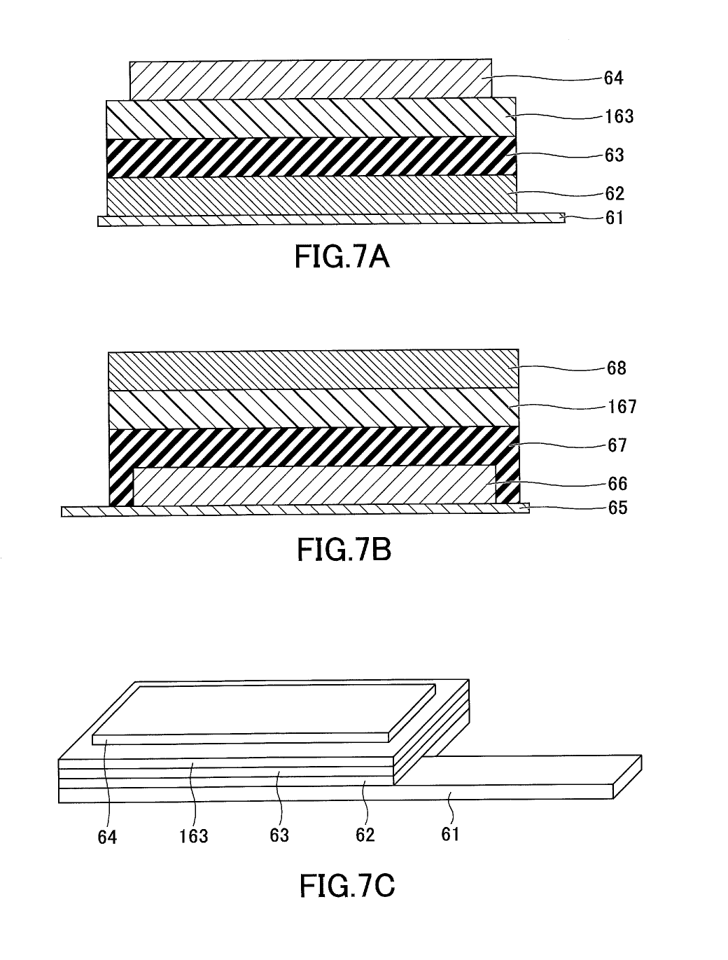

When producing a nonaqueous electrolytic power storage device 4, as illustrated in FIG. 7A, an anode material layer 62, a separator 63, a separator 163, and a cathode material layer 64 are stacked in this order over an anode current collector 61, as in the first embodiment first. The anode current collector 61, the anode material layer 62, the separator 63, the separator 163, and the cathode material layer 64 bond together.

Next, as illustrated in FIG. 7B, a cathode material layer 66, a separator 67, a separator 167, and an anode material layer 68 are stacked in this order over a cathode current collector 65 as in the first embodiment. The cathode current collector 65, the cathode material layer 66, the separator 67, the separator 167, and the anode material layer 68 bond together. Note that FIG. 7C is an example of a perspective view of the structure illustrated in FIG. 7A.

Thereafter, the electrode element 60B can be produced as illustrated in FIG. 4C, to which the nonaqueous electrolytic solution 51 is injected and sealed by the exterior 52, to complete the nonaqueous electrolytic power storage device 4 illustrated in FIG. 6.

As can be seen in the nonaqueous electrolytic power storage device 4, the second separators (separators 163 and 167) may be stacked over the first separators (separators 63 and 67), respectively. Furthermore, in addition to the effects described with the nonaqueous electrolytic power storage device 2, the following effects can be obtained with the nonaqueous electrolytic power storage device 4. That is, by forming the first separators (separators 63 and 67) of a ceramic material, and forming the second separators (separators 163 and 167) of a resin material, it becomes possible to shut down the battery safely if a short circuit is formed between the anode layer and the cathode layer accompanied by heat generation.

In other words, conventionally, in the case of a battery constituted with resin separators corresponding to the second separators (separators 163 and 167), a short circuit could be formed between the anode and the cathode, and if heat is generated, the resin contracts, which increases locations at which the resin separator does not exist between the anode and the cathode. This increases short-circuit locations, and consequently, heat generation due to the short circuits cannot be stopped.

On the other hand, by forming the first separators (separators 63 and 67) of a ceramic material, heat generation due to short circuit in the battery becomes permissible up to the melting point of the ceramic material. Consequently, even if heat is generated due to short circuit to an extent of melting the second separators (separators 163 and 167) formed of resin, existence of the first separators (separators 63 and 67) prevents short-circuit locations between the anode and the cathode from increasing. This enables to shut down the battery safely if a short circuit is formed between the anode layer and the cathode layer accompanied by heat generation.

Note that in FIG. 3, FIG. 5, and FIGS. 7A-7C, one or more sets of a cathode material layer, a separator, and an anode material layer may be further stacked. For example, in FIG. 3, an anode material layer, a separator, a cathode material layer, and a cathode current collector may be stacked in this order over the anode current collector 69, to connect the stacked cathode current collector with the cathode current collector 65 through the cathode lead wire 42. Also, an anode material layer, a separator, a cathode material layer, and a cathode current collector may be stacked in this order under the anode current collector 61, to connect the stacked cathode current collector with the cathode current collector 65 through the cathode lead wire 42. This enables to improve the energy density.

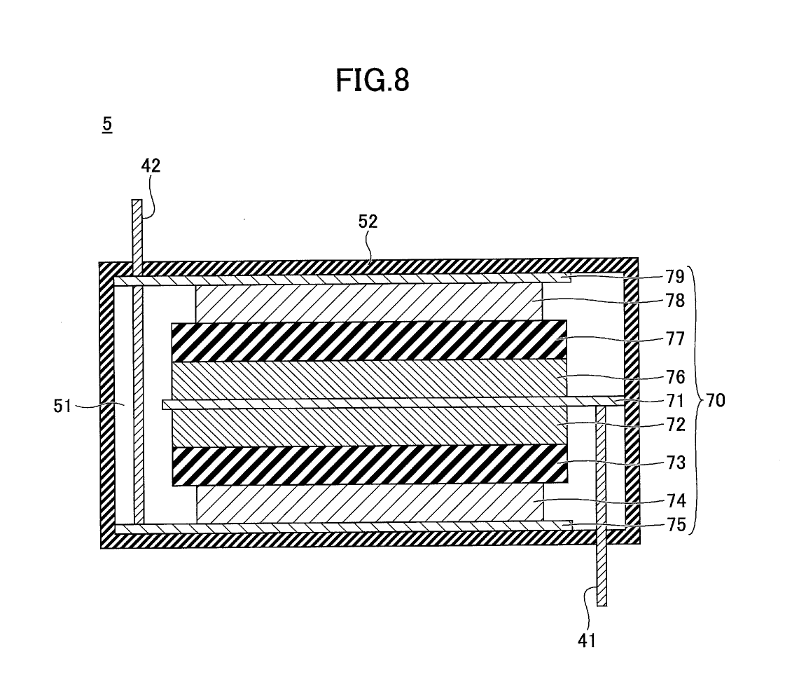

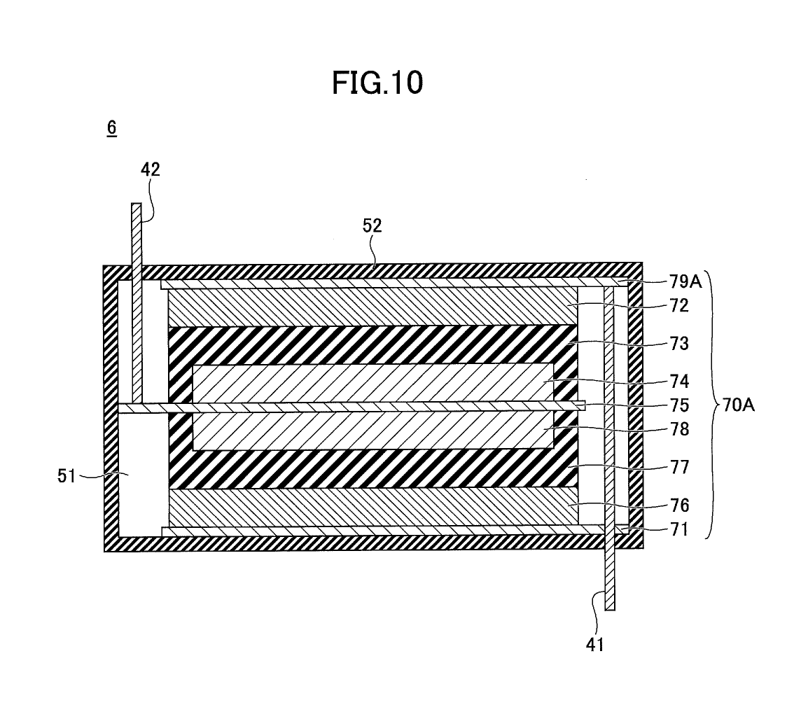

Also, in the case of FIG. 1 and FIG. 5, and FIG. 8 and FIG. 10 as will be described later, a separator may have a stacked-layer structure constituted with a first separator formed of a ceramic material, and a second separator formed of a resin material, as in the case of FIG. 6.

### Third Embodiment

FIG. 8 is a cross-sectional view illustrating an example of a nonaqueous electrolytic power storage device according to a third embodiment. Referring to FIG. 8, a nonaqueous electrolytic power storage device 5 has a structure in which a nonaqueous electrolytic solution 51 is injected into an electrode element 70, and is sealed by an exterior 52. The nonaqueous electrolytic power storage device 5 may include other members as necessary. The nonaqueous electrolytic power storage device 5 is not limited in particular and can be selected properly depending on the purpose; for example, a nonaqueous electrolytic solution secondary battery, and a nonaqueous electrolytic solution capacitor, and the like may be listed.

The electrode element 70 has a structure in which a cathode material layer 74, a separator 73, an anode material layer 72, an anode current collector 71, an anode material layer 76, a separator 77, a cathode material layer 78, and a cathode current collector 79 are stacked in this order over a cathode current collector 75. The anode material layer 72, the separator 73, and the cathode material layer 74 are bonded together below the anode current collector 71. Also, the anode material layer 76, the separator 77, and the cathode material layer 78 are bonded together over the anode current collector 71. In other words, the anode current collector 71 is bonded with both the anode material layer 72 and the anode material layer 76.

An anode lead wire 41 is connected to the anode current collector 71, and is pulled out of the exterior 52. A cathode lead wire 42 is connected to the cathode current collectors 75 and 79, and is pulled out of the exterior 52.

The material, thickness, and the like of the anode current collector 71, the cathode current collector 75, and the cathode current collector 79 may be substantially the same as, for example, those of the anode current collector 11 and the cathode current collector 21.

The configuration of the anode material layers 72 and 76 may be substantially the same as, for example, that of the anode material layers 12 and 13. However, it is not necessary to add an additive to the anode active material, and materials that can be used as the anode active material include, for example, coke; graphite such as artificial graphite and natural graphite; pyrolysate of an organic matter obtained under various pyrolysis conditions; and carbon materials such as amorphous carbon.

However, each of the anode material layers 72 and 76 may be formed to have a stacked structure of multiple layers, and as in the first embodiment, the concentration of the additive to the principal material is increased gradually in the layers while the separation becomes greater from the side of the anode current collector 71. This enables to bring substantially the same effects as in the first embodiment.

The configuration of the cathode material layers 74 and 78 may be substantially the same, for example, those of the cathode material layers 22 and 23, respectively. However, it is not necessary to add an additive to the cathode active material, and as the cathode active material, for example, a lithium nickel compound oxide, spinel manganese, a lithium-phosphate-based material, and the like may be used.

However, each of the cathode material layers 74 and 78 may be formed to have a stacked structure of multiple layers, and as in the first embodiment, the concentration of the additive to the principal material in the cathode material layer 74 is decreased gradually in the layered structure of the cathode material layer 74 while the separation becomes greater from the side of the cathode current collector 75; and the concentration of the additive to the principal material in the cathode material layer 78 is decreased gradually in the cathode material layer 78 while the separation becomes greater from the side of the cathode current collector 79. This enables to bring substantially the same effects as in the first embodiment.

The separators 73 and 77 may have, for example, substantially the same composition as the separators 63 and 67.

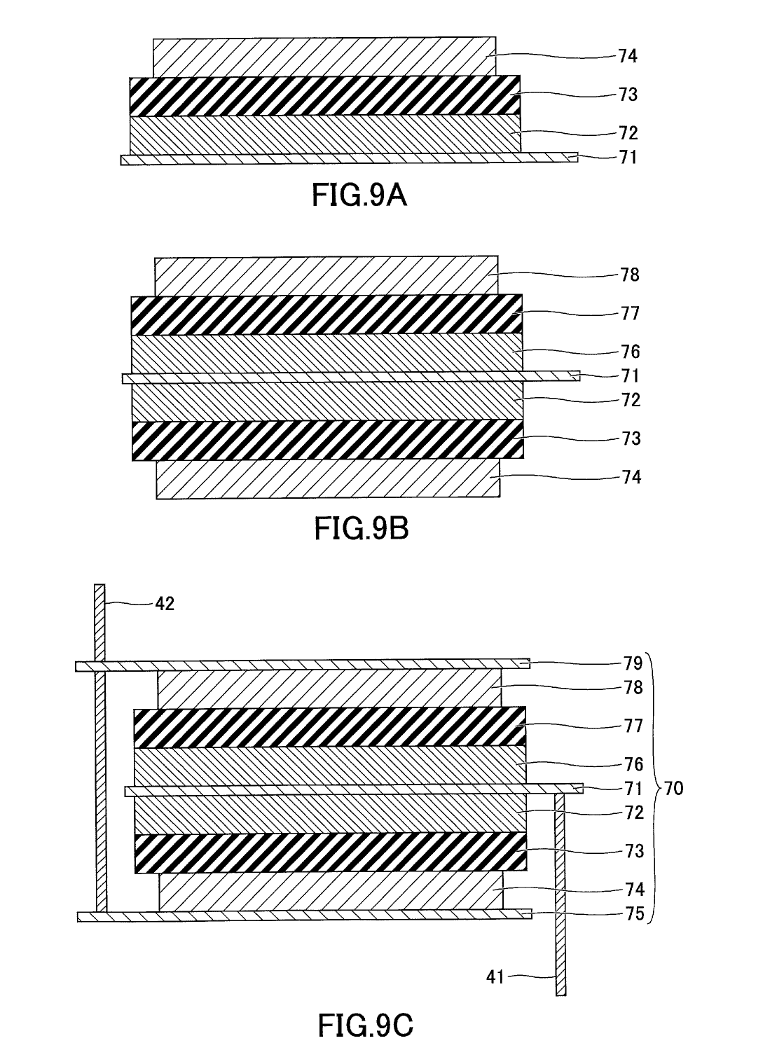

When producing a nonaqueous electrolytic power storage device 5, as illustrated in FIG. 9A, an anode material layer 72, a separator 73, and a cathode material layer 74 are stacked in this order over an anode current collector 71, as in the first embodiment first. The anode current collector 71, the anode material layer 72, the separator 73, and the cathode material layer 74 bond together.

Next, as illustrated in FIG. 9B, the stacked layer object illustrated in FIG. 9A is flipped to be up-side-down, and on a surface of the anode current collector 71 opposite to the anode material layer 72, an anode material layer 76, a separator 77, and a cathode material layer 78 are stacked in this order as in the first embodiment. The anode current collector 71, the anode material layer 76, the separator 77, and the cathode material layer 78 bond together.

Although production of the respective layers illustrated in FIG. 9A and FIG. 9B can be performed by any of the methods exemplified in the first embodiment, it is favorable to adopt an inkjet method that can bond layers next to each other. In the case of producing the layers by an inkjet method, after having applied slurry to the lower layer by the inkjet method, heating is performed up to a predetermined temperature to evaporate the solvent.

Next, as illustrated in FIG. 9C, the electrode element 70 is produced. Specifically, the cathode current collector 75 is placed under the cathode material layer 74. Also, it places the cathode current collector 79 is placed above the cathode material layer 78. Then, an anode lead wire 41 is joined to the anode current collector 71 by welding or the like, and an anode lead wire 42 is joined to the cathode current collectors 75 and 79 by welding or the like, to produce the electrode element 70. Note that the electrode element 70 may be viewed as an electrode element 60A produced by a different production method.

Note that in this method, although the cathode material layer 74 and the cathode current collector 75 do not bond together, a binder or the like may be sandwiched between the cathode material layer 74 and the cathode current collector 75, to bond the cathode material layer 74 and the cathode current collector 75 together. Similarly, although the cathode material layer 78 and the cathode current collector 79 do not bond together, a binder or the like may be sandwiched between the cathode material layer 78 and the cathode current collector 79, to bond the cathode material layer 78 and the cathode current collector 79 together.

After having completed the process illustrated in FIG. 9C, the nonaqueous electrolytic solution 51 is injected into the electrode element 70, and is sealed by the exterior 52, to complete the nonaqueous electrolytic power storage device 5 illustrated in FIG. 8.

In this way, in the nonaqueous electrolytic power storage device 5, layers next to each other bond together in the anode current collector 71, the anode material layer 72, the separator 73, the cathode material layer 74, the anode material layer 76, the separator 77, and the cathode material layer 78. Also, the anode current collector 71 combines with both the anode material layer 72 and the anode material layer 76. In other words, no relative position gap between the anode material layer and the cathode material layer is produced between electrode current collectors next to each other. Consequently, it brings the same effects as the second embodiment. Note that the method may be modified as illustrated in FIG. 10. In a nonaqueous electrolytic power storage device 6 illustrated in FIG. 10, the electrode element 70 of the nonaqueous electrolytic power storage device 5 is replaced by an electrode element 70A.

The electrode element 70A has an order of stacked layers different from the order in the electrode element 70. In other words, the electrode element 70A has a structure in which an anode material layer 76, a separator 77, a cathode material layer 78, a cathode current collector 75, a cathode material layer 74, a separator 73, an anode material layer 72, and an anode current collector 79A are stacked in this order over an anode current collector 71.

The cathode material layer 78, the separator 77, and the anode material layer 76 are bonded under the cathode current collector 75. Also, the cathode material layer 74, the separator 73, and the anode material layer 72 are bonded over the cathode current collector 75.

A cathode lead wire 42 is connected to the cathode current collector 75, and is pulled out of the exterior 52. An anode lead wire 41 is connected to the anode current collectors 71 and 79A, and is pulled out of the exterior 52. Note that the electrode element 70A may be viewed as an electrode element 60 produced by a different production method.

The nonaqueous electrolytic power storage device 6 may be produced by substantially the same method as the nonaqueous electrolytic power storage device 5. Note that in order to stack the anode material layer 72 that is broader than the cathode material layer 74, the separator 73 is formed so as to cover the side surfaces of the cathode material layer 74. Similarly, in order to stack the anode material layer 76 that is broader than the cathode material layer 78, the separator 77 is formed so as to cover the side surfaces of the cathode material layer 78.

In the nonaqueous electrolytic power storage device 6, no relative position gap between the anode material layer and the cathode material layer is produced between electrode current collectors next to each other as in the nonaqueous electrolytic power storage device 5. Consequently, it brings the same effects as the nonaqueous electrolytic power storage device 5.

Note that in FIG. 8 and FIG. 10, one or more sets of a cathode material layer, a separator, and an anode material layer may be further stacked. For example, in FIG. 8, a cathode material layer, a separator, an anode material layer, and an anode current collector may be stacked in this order over the cathode current collector 79, to connect the stacked anode current collector with the anode current collector 71 through the anode lead wire 41. Also, a cathode material layer, a separator, an anode material layer, and an anode current collector may be stacked in this order under the cathode current collector 75, to connect the stacked anode current collector with the anode current collector 71 through the anode lead wire 41. This enables to improve the energy density.

### APPLICATION EXAMPLE 1

In an application example 1, a nonaqueous electrolytic power storage device 1 illustrated in FIG. 1 was produced. Here, the produced cathode material layer had a single layer. In other words, on the side of the cathode 20, the concentration of the additive was not changed gradually in multiple layers.

Specifically, first, amorphous carbon as an additive was added to graphite as the principal material by the weight ratio of graphite to amorphous carbon being 8 to 2 to produce an anode active material, to which a binder, a conducting agent, and a solvent properly selected from among the materials described in the first embodiment were added to produce slurry of an anode material composite for the anode material layer 12.

Also, amorphous carbon as the additive was added to graphite as the principal material by the weight ratio of graphite to amorphous carbon being 6 to 4 to produce an anode active material, to which a binder, a conducting agent, and a solvent properly selected from among the materials described in the first embodiment were added to produce slurry of an anode material composite for the anode material layer 13.

Next, an 8-μm-thick copper collector base material was prepared as the anode current collector 11, to which the anode material composite for the anode material layer 12 was applied by 5 mg/cm² using an inkjet method, and was dried to be bonded with the anode material layer 12.

Next, the anode material composite for the anode material layer 12 was applied to the anode material layer 12 by 5 mg/cm² using the inkjet method, and was dried to be bonded with the anode material layer 13. As above, the anode 10 was produced in which the anode material layer 12 and the anode material layer 13 were stacked in this order over the anode current collector 11.

Next, a 15-μm-thick aluminum collector base material was prepared as the cathode current collector 21, on which a cathode material layer containing a nickel compound oxide as the principal material was bonded by 15 mg/cm², to produce the cathode 20. Then, the anode 10 and the cathode 20 were arranged to face each other through a 25-μm-thick separator 30 formed of a fine porous film made of polypropylene.

Then, an anode lead wire 41 was joined to the anode current collector 11 by welding, and a cathode lead wire 42 was joined to the cathode current collector 21 by welding, to produce the electrode element 40. Then, a nonaqueous electrolytic solution 51 containing 1.5M LiPF6 EC and DMC by the ratio of 1 to 1 was injected into the electrode element 40, and was sealed by using a lamination exterior material as the exterior 52, to produce the nonaqueous electrolytic power storage device 1.

### COMPARATIVE EXAMPLE 1

First, amorphous carbon as an additive was added to graphite as the principal material by the weight ratio of graphite to amorphous carbon being 7 to 3 to produce an anode active material, to which substantially the same binder, conducting agent, and solvent were added as in the application example, to produce slurry of an anode material composite.

Next, an 8-μm-thick copper collector base material was prepared as the anode current collector, to which the produced anode material composite was applied by 10 mg/cm² using the inkjet method, and was dried to obtain an anode material layer, to produce the anode on the anode current collector bonded with a single layer of the anode material layer 12.

With the other steps that were substantially the same as in the application example 1, a nonaqueous electrolytic power storage device according to the comparative example 1 was produced. This nonaqueous electrolytic power storage device is referred to as the “nonaqueous electrolytic power storage device 1X” for convenience' sake.

[Comparison of application example 1 with comparative example 1]

Charge and discharge cycles were performed for the nonaqueous electrolytic power storage devices 1 and 1X at 1C (a current value at which the devices can be completely discharged in one hour), to compare discharge capacity conservation rates after 500 cycles. Obtained results were 87% for the nonaqueous electrolytic power storage device 1 (application example 1), and 82% for the nonaqueous electrolytic power storage device 1X (comparative example 1).

Also, each of the nonaqueous electrolytic power storage devices 1 and 1X were disassembled to analyze the thickness of lithium ions deposited on the anode, by using XPS (X-ray Photoelectron Spectroscopy). Consequently, the quantity of lithium ions deposited in the nonaqueous electrolytic power storage device 1 (application example 1) was smaller compared with the quantity of lithium ions deposited in the nonaqueous electrolytic power storage device 1X (comparative example 1) by 12%.

In this way, amorphous carbon (additive) that causes less deposit of lithium ions on the surface of the anode 10 than graphite (the principal material), may be added to each layer of the anode 10. Then, the concentration of the additive to the principal material may be gradually increased from the side of the anode current collector 11 toward the side of the separator 30. It was confirmed that these processes enable to prevent lithium ions from depositing on the surface of the anode 10 while maintaining the performance of the nonaqueous electrolytic power storage device 1.

### APPLICATION EXAMPLE 2

In an application example 2, a nonaqueous electrolytic power storage device 1 illustrated in FIG. 1 was produced. Here, the produced anode material layer had a single layer. In other words, on the side of the anode 10, the concentration of the additive was not changed gradually in multiple layers.

Specifically, first, spinel manganese as an additive was added to lithium nickel compound oxide as the principal material by the weight ratio of lithium nickel compound oxide to spinel manganese being 6 to 4 to produce a cathode active material, to which a binder, a conducting agent, a thickener, and a solvent properly selected from among the materials described in the first embodiment were added to produce slurry of a cathode material composite for the cathode material layer 22.

Also, spinel manganese as the additive was added to lithium nickel compound oxide as the principal material by the weight ratio of lithium nickel compound oxide to spinel manganese being 8 to 2 to produce a cathode active material, to which a binder, a conducting agent, a thickener, and a solvent properly selected from among the materials described in the first embodiment were added to produce slurry of a cathode material composite for the cathode material layer 23.

Next, a 15-μm-thick copper collector base material was prepared as the cathode current collector 21, to which the cathode material composite for the cathode material layer 22 was applied by 7.5 mg/cm² using an inkjet method, and was dried to be bonded with the cathode material layer 22.

Next, the cathode material composite for the cathode material layer 23 was applied to the cathode material layer 22 by 7.5 mg/cm² using the inkjet method, and was dried to be bonded with the cathode material layer 23. As above, the cathode 20 was produced in which the cathode material layer 22 and the cathode material layer 23 were stacked in this order over the cathode current collector 21.

Next, an 8-μm-thick copper collector base material was prepared as the anode current collector 11, on which an anode material layer containing graphite as the principal material was bonded by 10 mg/cm², to produce the anode 10. Then, the anode 10 and the cathode 20 were arranged to face each other through a 25-μm-thick separator 30 formed of a fine porous film made of polypropylene.

Then, an anode lead wire 41 was joined to the anode current collector 11 by welding, and a cathode lead wire 42 was joined to the cathode current collector 21 by welding, to produce the electrode element 40. Then, a nonaqueous electrolytic solution 51 containing 1.5M LiPF6 EC and DMC by the ratio of 1 to 1 was sealed by using a lamination exterior material as the exterior 52, to produce the nonaqueous electrolytic power storage device 1.

### COMPARATIVE EXAMPLE 2

First, spinel manganese as an additive was added to lithium nickel compound oxide as the principal material by the weight ratio of lithium nickel compound oxide to spinel manganese being 7:3 to produce a cathode active material, to which a binder, a conducting agent, a thickener, and a solvent were added as in the application example 2, to produce slurry of a cathode material composite.

Next, a 15-μm-thick copper collector base material was prepared as a cathode current collector, to which the produced cathode material composite was applied by 15 mg/cm² using an inkjet method, and was dried to obtain a cathode material layer, to produce the cathode on the cathode current collector bonded with a single layer of the cathode material layer.

With the other steps that were substantially the same as in the application example 2, a nonaqueous electrolytic power storage device according to the comparative example 2 was produced. This nonaqueous electrolytic power storage device is referred to as the “nonaqueous electrolytic power storage device 1X” for convenience' sake.

### COMPARISON OF APPLICATION EXAMPLE 2 WITH COMPARATIVE EXAMPLE 2

Continuous loaded discharge at 5C was performed for the nonaqueous electrolytic power storage devices 1 and 1X, to measure and compare discharge capacity conservation rates. The discharge capacity conservation rate based on a discharge capacity obtained at 0.2 C was defined as 100%, and relative rates were calculated. Obtained results were 81% for the nonaqueous electrolytic power storage device 1 (application example 2), and 75% for the nonaqueous electrolytic power storage device 1X (comparative example 2).

In this way, spinel manganese (additive), which has a higher diffusibility with respect to lithium ions than the lithium nickel compound oxide, may be added to the lithium nickel compound oxide (the principal material) in each layer of the cathode 20. Then, the concentration of spinel manganese (additive) to the lithium nickel compound oxide (principal material) may be gradually decreased in each layer, from the side of the cathode current collector 21 toward the side of the separator 30. It was confirmed that these processes enables to accelerate diffusion of lithium ions within the nonaqueous electrolytic power storage device 1, and thereby, to improve the output performance.

### APPLICATION EXAMPLE 3

In an application example 3, a nonaqueous electrolytic power storage device 1 illustrated in FIG. 1 was produced. Here, the produced anode material layer had a single layer. In other words, on the side of the anode 10, the concentration of the additive was not changed gradually in multiple layers.

Specifically, the nonaqueous electrolytic power storage device 1 was produced in substantially the same way as in the application example 2 except for the additive; namely, spinel manganese was replaced with a lithium nickel compound oxide having a smaller particle diameter than that of the principal material.

### COMPARATIVE EXAMPLE 3

A nonaqueous electrolytic power storage device 1X was produced in substantially the same way as in the comparative example 2 except for the additive; namely, spinel manganese was replaced with a lithium nickel compound oxide having a smaller particle diameter than that of the principal material.

### COMPARISON OF APPLICATION EXAMPLE 3 WITH COMPARATIVE EXAMPLE 3

Continuous loaded discharge at 5C was performed for the nonaqueous electrolytic power storage devices 1 and 1X, to measure and compare discharge capacity conservation rates. The discharge capacity conservation rate based on a discharge capacity obtained at 0.2 C was defined as 100%, and relative rates were calculated. Obtained results were 76% for the nonaqueous electrolytic power storage device 1 (application example 3), and 70% for the nonaqueous electrolytic power storage device 1X (comparative example 3).

In this way, a lithium nickel compound oxide (additive) having a smaller particle diameter than that of the lithium nickel compound oxide (the principal material), may be added to the lithium nickel compound oxide (the principal material) in each layer of the cathode 20. Then, the concentration of the lithium nickel compound oxide (the additive) having the smaller particle diameter than that of the lithium nickel compound oxide (the principal material) may be gradually decreased in each layer, from the side of the cathode current collector 21 toward the side of the separator 30. It was confirmed that these processes enables to accelerate diffusion of lithium ions within the nonaqueous electrolytic power storage device 1, and thereby, to improve the output performance.

### APPLICATION EXAMPLE 4

In an application example 4, a nonaqueous electrolytic power storage device 1 illustrated in FIG. 1 was produced. Here, the produced anode material layer had a single layer. In other words, on the side of the anode 10, the concentration of the additive was not changed gradually in multiple layers.

Specifically, the nonaqueous electrolytic power storage device 1 was produced in substantially the same way as in the application example 2 except for the additive; namely, spinel manganese was replaced with a lithium vanadium phosphate.

### COMPARATIVE EXAMPLE 4

A nonaqueour. electrolytic power storage device 1X was produced in substantially the same way as in the comparative example 2 except for the additive; namely, spinel manganese was replaced with a lithium vanadium phosphate.

### COMPARISON OF APPLICATION EXAMPLE 4 WITH COMPARATIVE EXAMPLE 4

Continuous loaded discharge at 5C was performed for the nonaqueous electrolytic power storage devices 1 and 1X, to measure and compare discharge capacity conservation rates. The discharge capacity conservation rate based on a discharge capacity obtained at 0.2 C was defined as 100%, and relative rates were calculated. Obtained results were 86% for the nonaqueous electrolytic power storage device 1 (application example 4), and 79% for the nonaqueous electrolytic power storage device 1X (comparative example 4).

In this way, a lithium vanadium phosphate (additive), which has a higher diffusibility with respect to lithium ions than the lithium nickel compound oxide, may be added to the lithium nickel compound oxide (the principal material) in each layer of the cathode 20. Then, the concentration of lithium vanadium phosphate (additive) to the lithium nickel compound oxide (principal material) may be gradually decreased in each layer, from the side of the cathode current collector 21 toward the side of the separator 30. It was confirmed that these processes enables to accelerate diffusion of lithium ions within the nonaqueous electrolytic power storage device 1, and thereby, to improve the output performance.

As above, the preferred embodiments have been described in detail. Note that the present invention is not limited to the above embodiments, which may be changed and replaced in various ways without departing from the scope described in the claims.

For example, in the first embodiment, although an example has been described in which the anode 10 and the cathode 20 are used in the nonaqueous electrolytic power storage device 1, it is not limited as such; the anode 10 and the cathode 20 can also be used in a power storage device using a gel electrolyte, and substantially the same effects can be obtained as used in the nonaqueous electrolytic power storage device 1.

The present application claims priority under 35 U.S.C. § 119 of Japanese Patent Application No. 2017-044425 filed on Mar. 8, 2017, and Japanese Patent Application No. 2017-117777 filed on Jun. 15, 2017, the entire contents of which are hereby incorporated by reference.

What is claimed is:

1. An electrode for an anode or a cathode of a power storage device, comprising:
an electrode current collector; and
a plurality of electrode material layers stacked on one side of the electrode current collector, and configured to store and discharge lithium ions,
wherein in a case where the electrode is to be used as the anode,
each of the electrode material layers include,; a first material and a second material that causes less deposit of the lithium ions on a surface of the anode than the first material, and
the farther the electrode material layer is placed from the electrode current collector, the greater a ratio of a weight of the second material to a total weight of the first material and the second material becomes, and
wherein in a case where the electrode is to be used as the cathode,
each of the electrode material layers includes a third material and a fourth material that has a higher diffusibility with respect to lithium ions than the third material, and
the farther the electrode material layer is placed from the electrode current collector, the less a ratio of a weight of the fourth material to a total weight of the third material and the fourth material becomes.

2. The electrode as claimed in claim 1, wherein in the case where the electrode is to be used as the cathode, each of the electrode material layers includes a lithium nickel compound oxide being LiNi_{X}Co_{Y}Mn_{Z}O₂ (where X+Y+Z=1), spinel manganese, or a lithium-phosphate-based material having a basic skeleton of Li_{X}Me_{Y}(PO4)_{Z} (where 0.5≤X≤4, Me being transition metal, 0.5≤Y≤2.5, and 0.5≤Z≤3.5).

3. The electrode as claimed in claim 2, wherein in the case where the electrode is to be used as the cathode, the third material is a lithium nickel compound oxide being LiNi_{X}Co_{Y}Mn_{Z}O₂ (where X+Y+Z=1), and the fourth material is spinel manganese or a lithium-phosphate-based material having a basic skeleton of Li_{X}Me_{Y}(PO4)_{Z} (where 0.5≤X≤4, Me being transition metal, 0.5≤Y≤2.5, and 0.5≤Z≤3.5).

4. The electrode as claimed in claim 2, wherein in the case where the electrode is to be used as the cathode, the third material is a lithium nickel compound oxide being LiNi_{X}Co_{Y}Mn_{Z}O₂ (where X+Y+Z=1), and the fourth material is a lithium nickel compound oxide being LiNi_{X}Co_{Y}Mn_{Z}O₂ (where X+Y+Z=1) having a smaller particle diameter than the third material.

5. The electrode as claimed in claim 1, wherein in the case where the electrode is to be used as the anode, the second material is amorphous carbon.

6. The electrode element having both or one of the electrode being the anode as claimed in claim 1 and the electrode being the cathode as claimed in claim 1, wherein the electrode includes:
the anode configured to store and emit lithium ions,
the cathode configured to store and emit the lithium ions, and
an insulating layer placed between the cathode and the anode, and having permeability with respect to the lithium ions.

7. An electrode element, comprising:
a first anode material layer configured to store and emit lithium ions;
a first insulating layer having permeability with respect to lithium ions;
a first cathode material layer configured to store and emit lithium ions;
a cathode current collector;
a second cathode material layer configured to store and emit lithium ions;
a second insulating layer having permeability with respect to lithium ions;
a second anode material layer configured to store and emit lithium ions; and
a second anode current collector,
each of the layers being stacked in order on one side of a first anode current collector,
wherein the first anode material layer, the first insulating layer, and the first cathode material layer are bonded together,
wherein the second cathode material layer, the second insulating layer, and the second anode material layer are bonded together, and
wherein the first anode current collector and the second anode current collector are connected to each other.

8. An electrode element, comprising:
a first cathode material layer configured to store and emit lithium ions;
a first insulating layer having permeability with respect to lithium ions;
a first anode material layer configured to store and emit lithium ions;
an anode current collector;
a second anode material layer configured to store and emit lithium ions;
a second insulating layer having permeability with respect to lithium ions;
a second cathode material layer configured to store and emit lithium ions; and
a second cathode current collector,
each of the layers being stacked in order on one side of a first cathode current collector,
wherein the first cathode material layer, the first insulating layer, and the first anode material layer are bonded together,
wherein the second anode material layer, the second insulating layer, and the second cathode material layer are bonded together, and
wherein the first cathode current collector and the second cathode current collector are connected to each other.

9. The electrode element as claimed in claim 7, wherein the first anode current collector and the first anode material layer are bonded together, and the cathode current collector and the second cathode material layer are bonded together.

10. The electrode element as claimed in claim 7, wherein the one side of the cathode current collector and the second cathode material layer are bonded together, and another side of the cathode current collector and the first cathode material layer are bonded together.

11. The electrode element as claimed in claim 8, wherein the first cathode current collector and the first cathode material layer are bonded together, and the anode current collector and the second anode material layer are bonded together.

12. The electrode element as claimed in claim 8, wherein the one side of the anode current collector and the second anode material layer are bonded together, and another side of the anode current collector and the first anode material layer are bonded together.

13. The electrode element as claimed in claim 6, wherein a material of the insulating layer is a particulate ceramic.

14. The electrode element as claimed in claim 7, wherein a material of the first insulating layer and the second insulating layer is a particulate ceramic.

15. A nonaqueous electrolytic power storage device, comprising:
the electrode element as claimed in claim 6;
a nonaqueous electrolytic solution injected into the electrode element; and
an exterior configured to seal the electrode element and the nonaqueous electrolytic solution.
